(19) United States
(12) Patent Application Publication
(10) Pub. No.: US 2025/0361756 A1
(43) Pub. Date: Nov. 27, 2025

(54) METHOD AND SYSTEM FOR POWERING COMPONENTS AT A DOOR OF AN AUTOMOTIVE VEHICLE

(71) Applicant: FCA US LLC, Auburn Hills, MI (US)

(72) Inventor: Mark S. Grimes, Bruce Township, MI (US)

(21) Appl. No.: 18/670,280

(22) Filed: May 21, 2024

(51) Int. Cl. E05D 11/00; B60J 5/04; B60R 16/03; H02J 50/10

(52) U.S. Cl. CPC E05D 11/0081; B60J 5/0487; B60R 16/03; H02J 50/10; E05Y 2900/531

(57) ABSTRACT

A vehicle includes a body, a door and a hinge rotatably coupling the body and the door. The hinge has a first inductive coil and a second inductive coil adjacent to the first inductive coil. A load is coupled within the door and is electrically coupled to the second inductive coil.

### FIELD

The present disclosure relates to systems and methods for a vehicle, and in particular to systems and methods for wirelessly transferring power to components in a door of a vehicle.

### BACKGROUND

This section provides background information related to the present disclosure which is not necessarily prior art.

The popularity of off road vehicles Is increasing. Off road vehicles typically are all-wheel drive. Other features include removable tops and removable doors to provide an open-air feel. The Jeep brand is one example of a vehicle brand that includes removable doors. Removable doors may include various electrical items such as power windows, power locks, mirrors and lights. To remove the doors, a body electrical connector must be disconnected and protected from damage while the doors are removed from the vehicle. Damage to the connectors is not uncommon. When removing the door, the body side connector must be covered to prevent contamination.

### SUMMARY

This section provides a general summary of the disclosure, and is not a comprehensive disclosure of its full scope or all of its features.

The present disclosure provides a wireless power connection between the vehicle body and the door to provide a sufficient amount of power to power the various electrical components within the door.

In one aspect of the disclosure, a vehicle includes a body, a door and a hinge rotatably coupling the body and the door. The hinge has a first inductive coil and a second inductive coil adjacent to the first inductive coil. A load is coupled within the door and is electrically coupled to the second inductive coil.

In another aspect of the disclosure, a method of operating a vehicle includes providing a first electrical current to a first inductive coil disposed at a first hinge member fixedly coupled to a body of the vehicle, inductively coupling the first inductive coil to a second inductive coil positioned at a second hinge member fixedly coupled to a door to induce a second electrical current; and powering a load at the door.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is perspective view of a vehicle having a removable door.

FIG. 1B is an enlarged side view of a vehicle door hinge induction system according to the present disclosure.

FIG. 1C is a partial side view of a vehicle having a door hinge induction system according to the present disclosure.

FIG. 1D is an enlarged side view of a door hinge having induction coils therein.

FIG. 1E is a top view of a door hinge having the induction coils therein.

FIG. 2A is a schematic block diagrammatic view of the induction system.

FIG. 2B is a detailed block diagrammatic view of a door electrical system.

FIG. 3 is a flow chart of the method of operating the system.

Corresponding reference numerals indicate corresponding parts throughout the several views of the drawings.

### DETAILED DESCRIPTION

Example embodiments will now be described more fully with reference to the accompanying drawings.

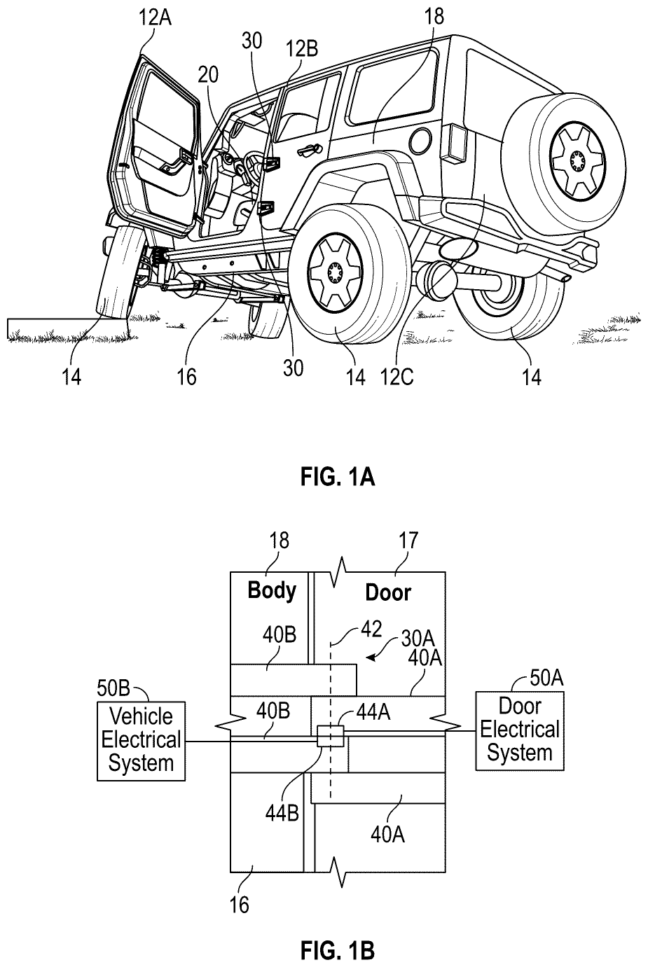

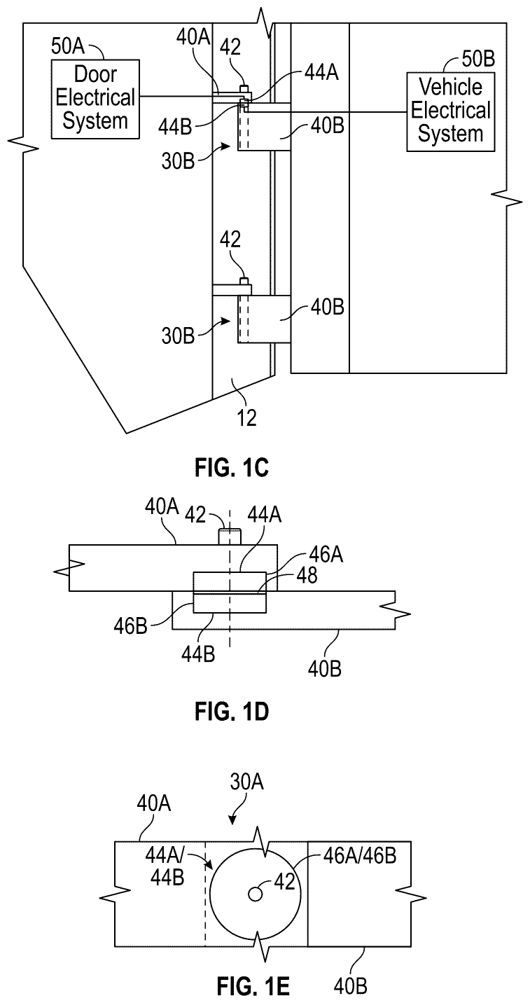

Referring now to FIG. 1A, a vehicle 10, such as a Jeep Wrangler®, is set forth. However, the vehicle 10 may be any vehicle having one or more removable doors 12. In this view, a front left door 12A and rear left door 12B are illustrated. A rear door 12C may also be configured as removable. The doors 12A, 12B, 12C are collectively referred to as doors 12.

As shown in FIG. 1A, vehicle 10 includes a plurality of wheels and tires 14. The vehicle 10 further includes a frame 16 supported by the plurality of wheels and tires 14 and a body 18. In some vehicles, the frame 16 and body are integrally formed as a unibody.

A seat 20 is operatively supported by the frame 16. The illustrative seats 20 include bench seats, bucket seats, and other suitable support members. In addition to the seat 20, the vehicle 10 may further include a passenger seat. Illustrative passenger seats include bench seats, bucket seats, and other suitable support members.

Referring now also to FIGS. 1B, 10, 1D and 1E the door 12 is supported by the body 18 by hinges 30A. In FIG. 1B the hinges 30A are external hinges. However, internal hinges 30B may be used. Internal hinges 30B are illustrated in FIG. 1C. The external hinges 30A and the internal hinges 30B have a first hinge member 40A fixedly coupled to the door 12 and a second hinge member 40B fixedly coupled to the body 18. Multiple members 40A and 40B may be used to form a hinge. A pin 42 extends through the hinge members 40A and 40B to allow the door 12 to rotate around the axis of the pin 42. That is, the members 40A and 40B and the respective coil 44A, 44B move relative to each other.

An electrically inductive coil 44A is disposed at the first member 40A adjacent to a second electrically inductive coil 44B in the second member 40B. The inductive coil 44A may be in a recess 46A in the first member 40A and is in communication with a door electrical system 50A. The second inductive coil 44B may be in a recess 46B in the second member 40B and is in communication with the vehicle electrical system. The inductive coils 44A, 44B are therefore slightly spaced apart by a gap 48 to prevent friction wear.

As shown best in FIG. 1E, the hinge 30A has the inductive coils 44A/44B disposed around the pin 42 in recesses 46A, 46B of the first member 40A and the second member 40B, respectively.

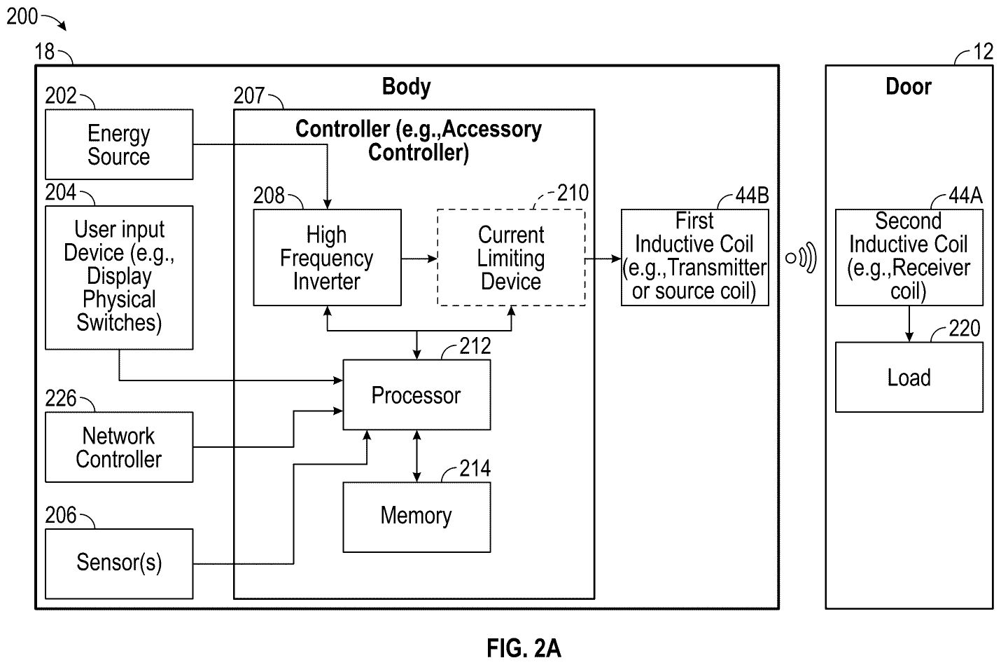

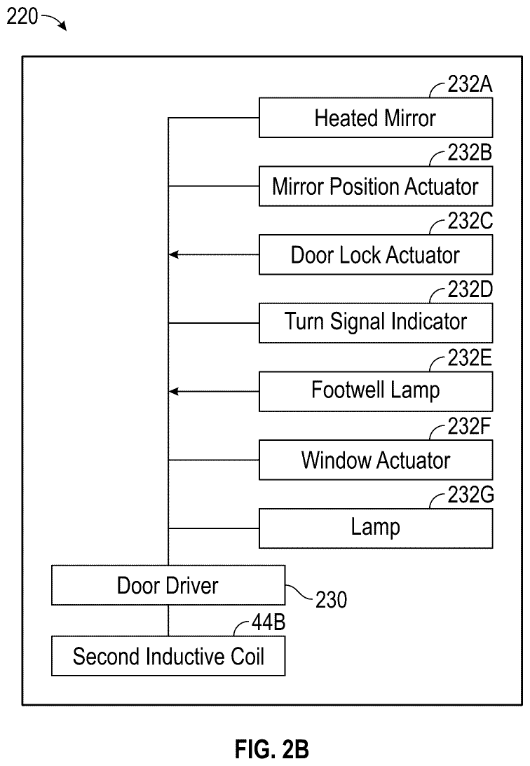

Referring now to FIG. 2, a block diagram of a vehicle control system 200, such as a vehicle control system 200 and/or a vehicle energy source charging system is illustrated. The body 18 of the vehicle 10 includes components, sub-systems, and/or devices of the vehicle control system 200. For example, the vehicle control system 200 and/or the vehicle 10 includes an energy source 202, a user interface 204, one or more sensor 206, a controller (e.g., an accessory controller) 207, a network controller 226, a high frequency inverter 208, a current limiting circuitry 210, a processor 212, a memory 214, the second inductive coil 44B, the first inductive coil 44A (all of the preceding part of the vehicle electrical system 50B) and a load 220, the load being part of the door electrical system 50A.

The vehicle control system 200 includes at least one energy source (e.g., batteries, stators, regulators, ferrous cores, and/or other types of energy sources) 202. The energy source 202 provides power (e.g., 12, 14, 48 Volts) to one or more components, devices, and/or sub-systems of the vehicle control system 200. In some examples, the energy source 202 provides power to one or more energy transfer devices (e.g., energy transfer circuitry), such as the first inductive coil 44A and the second inductive coil 44B. Additionally, and/or alternatively, the energy source 202 of the vehicle 10 provides power to second components, such as the load 220 in the door.

The user input device 204 includes one or more digital input devices such as switches on the steering members and/or voice command devices, physical switches, push buttons, levers, knobs, hard keys, soft keys, temperature selectors (e.g., analog or digital), user interfaces (e.g., displays and/or touch screens), and/or other types of devices capable of receiving user input from a user. Additionally, and/or alternatively, the user input device 204 is a voice command device, such as a microphone array. For example, the user may provide voice commands using the microphone array. The headset and/or microphone array provides the voice commands (e.g., one or more temperature settings) to the processor 212.

The network controller 226 controls communications between the vehicle 10 and other devices using one or more network components. In some instances, network controller 226 of the vehicle 10 communicates with paired devices over a wireless network (e.g., via a wireless or Wi-Fi chip). An illustrative wireless network is a radio frequency network utilizing a BLUETOOTH protocol. In this example, the network controller 226 is operatively coupled to and/or includes a radio frequency antenna. Network controller 226 controls the pairing of devices, and/or servers to the vehicle 10 and the communications between vehicle 10 and the remote devices. Further, the network controller 226 communicates with the controller 207, such as receiving information from the processor 212 and/or providing information to the processor 212.

The vehicle control system 200 is configured to transfer energy between on-board vehicle components and/or between on-board components and external components. For example, in one embodiment, the vehicle control system 200 is configured to provide energy transfer to various components in the door 12.

The sensor(s) 206 includes one or more sensors and/or devices that detect, determine, monitor and/or provide sensor information indicating various parameters of the vehicle 10 or the environment surrounding the vehicle 10. The types of sensors and/or operations of sensors include but are not limited to a temperature sensor, a light sensor, global positioning sensors and the like.

The controller 207 (e.g., an accessory controller and/or a vehicle controller) includes one or more processors (e.g., processor 212), the memory (e.g., memory 214), the high frequency inverters 208, and/or the current limiting device 210. The controller 207 may be a single device or a distributed device, and the functions of the controller 207 (e.g., processor 212) may be performed by hardware and/or as computer instructions on a non-transient computer readable storage medium, such as the memory 214. In some instances, the controller 207 forms a portion of a processing subsystem including one or more computing devices having memory, processing, and communication hardware. The controller 207 may alternatively include one or more application-specific integrated circuits (ASICs), field-programmable gate arrays (FPGAs), digital signal processors (DSPs), hardwired logic, or combinations thereof.

The memory 214 is a computer-readable medium in the form of volatile and/or nonvolatile memory and is removable, nonremovable, a combination, and/or non-transitory. Computer-readable medium examples include Random Access Memory (RAM), Read Only Memory (ROM), Electronically Erasable Programmable Read Only Memory (EEPROM), flash memory, optical or holographic media, magnetic storage devices, and/or any other medium that can be used to store information and can be accessed by an electronic device, such as the processor 212. Additionally, and/or alternatively, the memory 214 is representative of multiple memories.

When present, the high frequency inverter(s) 208 is any type of circuitry that converts between DC current and alternating current (AC). For example, the energy source 202 provides DC current to the controller 207. A first energy transfer device (e.g., the first inductive coil 216 and/or the first conductive material 222) may use AC current to transfer energy to a second energy transfer device (e.g., the second inductive coil 218 and/or the second conductive material 224). The high frequency inverter 208 converts the DC current from the energy source 202 to the AC current and provides the AC current to the current limiting circuitry 210 and/or the first energy transfer device.

When present, the current limiting device 210 includes one or more devices and/or circuitry that limits the current provided to the energy transfer devices. For example, the current limiting device 210 is any type of circuitry and/or device that limits the current, power, and/or voltage. The current limiting device 210 is operatively coupled to the processor 212. The processor 212 provides signals, instructions, and/or other indications to the current limiting device 210 to limit the current output to the first and second energy transfer devices.

In some variations, the current limiting device 210 is included within the high frequency inverter 208. For instance, the high frequency inverter 208 converts the DC current to the AC current and limits the current and/or voltage based on instructions from the processor 212. After converting and/or limiting the current, the high frequency inverter 208 provides the current to the first energy transfer device, such as the first inductive coil 216.

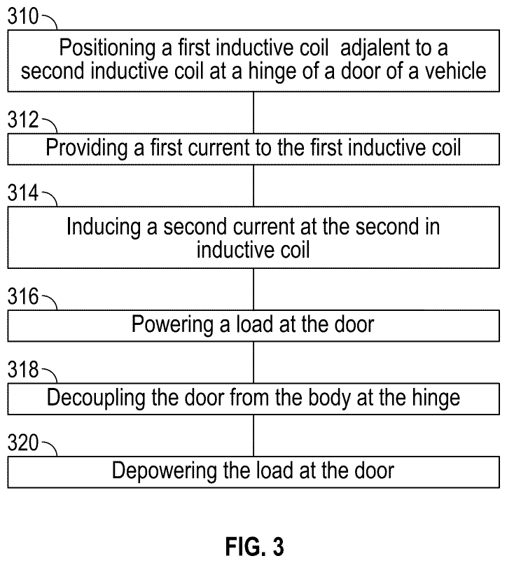

In some examples and as mentioned above, the high frequency inverter 208 is optional. For example, referring to FIGS. 3 and 5, when present, the high frequency inverter 208 converts the DC current to the AC current and provides the current to the current limiting device 210. When absent, the energy source 202 provides the DC current to the current limiting device 210. Based on instructions from the processor 212, the current limiting device 210 limits the current and/or voltage and provides the output to the first energy transfer device, such as the first inductive coil 44A. In some instances, the current limiting device 210 is a buck converter (e.g., a DC to DC converter) and/or a slip ring.

The controller 207 is operatively coupled to, communicates with, and/or controls the devices, components, and/or sub-systems of the vehicle 10. For example, the controller 207 communicates with the energy source 202, the user input device 204, and/or the sensors 206. In some instances, the controller 207 receives a current from the energy source 202. The current may be a DC current. The high frequency inverter 208 converts the DC current to AC current and provides the AC current to the current limiting device 210.

In some examples, the controller 207 (e.g., processor 212) receives user input from the user input device 204. In some variations, the controller 207 (e.g., processor 212) receives sensor information from the sensors 206. In some instances, based on the sensor information and/or the user input, the controller 207 (e.g., processor 212) provides and/or limits the current to one or more energy transfer devices. For example, the processor 212 provides a signal to the current limiting device 210 to provide and/or limit the current to the energy transfer devices. In other words, the processor 212 may control, monitor, and/or manage the operation of the transfer of energy between the vehicle 10 and the components of the door 12.

The illustrative vehicle control system 200 and/or the vehicle 10 is not intended to suggest any limitation as to the scope of use or functionality of embodiments of the present disclosure. Neither should the illustrative vehicle control system 200 and/or the vehicle 10 be interpreted as having any dependency or requirement related to any single component and/or system or combination of components and/or systems illustrated therein. Additionally, various components and/or systems depicted in FIGS. 1-2, in embodiments, may be integrated with various ones of the other components and/or systems depicted therein (and/or components and/or systems not illustrated). The functionalities of the vehicle control system 200 and/or the vehicle 10 will be described below.

The energy transfer devices, such as the first inductive coil 44A and, the second inductive coil 44B, are any type of devices that transfer energy wirelessly (e.g., without a wired connection). For example, the energy transfer devices may transfer energy from the vehicle 10 (e.g., from the energy source 202) to one or more components and/or systems in the door 12.

For example, the first inductive coil 44A uses inductance (e.g., inductive power transfer) to transfer energy (e.g., current) to the second inductive coil 44B. For example, providing a current to the first inductive coil 44A causes the first inductive coil 44B to create a magnetic field. By bringing the second inductive coil 44B in close enough proximity to the first inductive coil 44BA (e.g., the created magnetic field), the magnetic field induces the second inductive coil 44B to provide a current to the load 220. In other words, by providing a current from the controller 207 to the first inductive coil 44A, the first inductive coil 44A induces a current on the second inductive coil 44B. The second inductive coil 44B provides the current to the load 220. In some instances, using induction, the first inductive coil 44A does not need to physically touch the second inductive coil 44B transfer energy to the second inductive coil 44B (e.g., the coils 216, 218 are separated by a certain distance or gap 48). In some examples, the first inductive coil 44A and/or the second inductive coil 44B may include one or more coils. In other words, the first and second inductive coils 44A and 44B may include multiple inductive coils (e.g., three coils) used to supply power to the load 220.

Referring now to FIG. 2B, the load 220 receives current from the second inductive coil 218. The load 220 may include various loads depending on the type and position of the door 12. The load 220 may include a door driver 230 that distributes the load to various components. The door driver 230 may be coupled to various loads within the door 12. The door driver 230 is an optional component. That is, all of the loads 220 may be coupled directly to the second inductive coil 44B. The loads 220 may include a heated mirror 232A. The heated mirror 232A may be provided on the front door 12A. A mirror position actuator 232B may also be a load 220 to form a power mirror. A door lock actuator 232C is used to actuate door locks within the door 12. A turn signal indicator 232D may also be included as a load 220. The turn signal indicator 232D may be part of the mirror assembly or a separate component. Another load is a footwell lamp 232E. A window actuator 232F may also be included as part of the load 220. The window actuator 232F moves the window upward and downward and may be referred to as a power window. Lamps 232G may also be included as a load. Various lamps including interior and exterior lamps may be provided. For example, welcome lamps may be provided on the exterior of the door 12. The lamp 232G may also be used to illuminate various components such as the door handles on both the interior and exterior of the vehicle 10.

Referring now to FIG. 3, a method of powering a load at a door is set forth. In step 310, a first inductive coil is positioned adjacent to a second inductive coil at a hinge of a door of a vehicle. In step 312, a first current is provided to the first inductive coil. In step 314, a second current at a second inductive coil is induced by the first current in the first inductive coil. In step 316, a load at the door is powered by the second current. In step 318, the door is decoupled from the body at the hinge. The decoupling of the door is performed by removing the pin at the hinge or each pin of each hinge should more than one hinge be used. Decoupling the door does not require disconnecting any electrical components. In step 320, the load at the door is depowered in response to the second inductive coil being separated from the first inductive coil and current induction is no longer performed.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A vehicle comprising:
a body;
a door;
a hinge rotatably coupling the body and the door, the hinge comprising a first inductive coil and a second inductive coil adjacent to the first inductive coil; and
a load coupled within the door electrically coupled to the second inductive coil.

2. The vehicle of claim 1 wherein the door comprises a removable door.

3. The vehicle of claim 1 wherein the hinge comprises a first member fixedly coupled to the body, a second member fixedly coupled to the door, a pin coupling the first member and the second member.

4. The vehicle of claim 3 wherein the first inductive coil is coupled to the first member and the second member is coupled to the second coil.

5. The vehicle of claim 4 wherein the first member comprises a first recess having the first coil disposed therein and the second member comprises a second recess having the second coil disposed therein.

6. The vehicle of claim 1 wherein the load comprises a door driver coupled to the second inductive coil.

7. The vehicle of claim 6 wherein the door driver is coupled to a plurality of loads.

8. The vehicle of claim 7 wherein the plurality of loads comprises at least two of a heated mirror, a mirror position actuator, a door lock actuator, a turn signal indicator, a footwell lamp, a window actuator, and a lamp.

9. The vehicle of claim 1 wherein the hinge comprises an exterior hinge.

10. The vehicle of claim 1 wherein the hinge comprises an interior hinge.

11. The vehicle of claim 1 wherein the second inductive coil is coupled to a load, the load comprises at least one of a heated mirror, a mirror position actuator, a door lock actuator, a turn signal indicator, a footwell lamp, a window actuator, and a lamp.

12. A method of operating a vehicle comprising:
providing a first electrical current to a first inductive coil disposed at a first hinge member fixedly coupled to a body of the vehicle;
inductively coupling the first inductive coil to a second inductive coil positioned at a second hinge member fixedly coupled to a door to induce a second electrical current; and
powering a load at the door.

13. The method of claim 12 further comprising decoupling the first hinge member from the second hinge member separating the first inductive coil from the second inductive coil.

14. The method of claim 12 further comprising, in response to separating, depowering the load at the door.

15. The method of claim 12 wherein powering the load comprises powering at least one of a heated mirror, a mirror position actuator, a door lock actuator, a turn signal indicator, a footwell lamp, a window actuator, and a lamp.

16. The method of claim 12 wherein powering the load comprises powering a door driver.

17. The method of claim 16 wherein after powering the door driver comprises powering, from the door driver at least one of a heated mirror, a mirror position actuator, a door lock actuator, a turn signal indicator, a footwell lamp, a window actuator, and a lamp.

18. The method of claim 12 wherein providing the first electrical current to the first inductive coil disposed at the first hinge member comprises providing the first electrical current to the first inductive coil disposed at the first hinge member of an external hinge.

19. The method of claim 12 wherein providing the first electrical current to the first inductive coil disposed at the first hinge member comprises providing the first electrical current to the first inductive coil disposed at the first hinge member of an internal hinge.
